(19) United States
(12) Patent Application Publication
(10) Pub. No.: US 2026/0178630 A1
(43) Pub. Date: Jun. 25, 2026

(54) PREFILL OPTIMIZATION FOR LLM COMPUTATIONS

(71) Applicant: Snowflake Inc., Bozeman, MT (US)

(72) Inventors: Yuxiong He, Redmond, WA (US); Aurick Qiao, Pittsburgh, PA (US); Samyam Rajbhandari, Sammamish, WA (US); Zhewei Yao, Redmond, WA (US)

(21) Appl. No.: 18/990,813

(22) Filed: Dec. 20, 2024

(51) Int. Cl. G06F 16/3332; G06F 16/338; G06F 16/387

(52) U.S. Cl. CPC G06F 16/3334; G06F 16/338; G06F 16/387

(57) ABSTRACT

Described is a system for optimizing LLM inference by modifying the LLM to skip processing of a subset of layers for input tokens. The data platform determines a modified architecture that identifies and bypasses specific layers and training the modified LLM through a distillation process to configure parameter weightings for the adjusted architecture. Upon receiving a text input query from a user, the data platform processes the query using the modified LLM, leveraging the layer-skipping mechanism to improve computational efficiency without compromising output quality. The processed query generates a response, which is subsequently displayed to the user.

### TECHNICAL FIELD

Embodiments of the disclosure relate generally to cloud data platforms and, more specifically, to prefilling optimization for LLM computations.

### BACKGROUND

Network-based database systems may be provided through a cloud data platform, which allows organizations, customers, and users to store, manage, and retrieve data from the cloud. With respect to this type of data processing, a cloud data platform could implement online transactional processing, online analytical processing, and/or another type of data processing. Moreover, a cloud data platform could be or include a relational database management system and/or one or more other types of database management systems.

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to types of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. Indeed, the data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 illustrates an example computing environment that includes a cloud data platform, according to some examples.

FIG. 2 is a block diagram illustrating components of a compute service manager of the cloud data platform, according to some examples.

FIG. 3 illustrates an example method for prefill optimization for LLM computations, according to some examples.

FIG. 4 is a diagram illustrating the skipping of the second half of the hidden layers for input token processing for the LLM, according to some examples.

FIG. 5 is an architectural diagram illustrating merging of layers, according to some examples.

FIG. 6 illustrates training and use of a machine-learning program, according to some examples.

FIG. 7 illustrates a machine-learning pipeline, according to some examples.

FIG. 8 illustrates a diagrammatic representation of a machine in the form of a computer system within which a set of instructions may be executed for causing the machine to perform any one or more of the methodologies discussed herein, in accordance with some examples of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “database system,” or merely “a platform.”

In the present disclosure, physical units of data that are stored in a data platform- and that make up the content of, e.g., database tables in user accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, on, etc.) what is referred to herein as an “internal storage location.” If stored external to the data platform, a given file is referred to herein as an “external file” and is referred to as being stored in (or at, on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a user account. The data platform may include one or more databases that are respectively maintained in association with any number of user accounts (e.g., accounts of one or more data providers or other types of users), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular user accounts as well. Users and/or executing processes that are associated with a given user account may, via one or more types of clients, be able to cause data to be ingested into the database, and may also be able to manipulate the data, add additional data, remove data, run queries against the data, generate views of the data, and so forth.

In an implementation of a data platform, a given database (e.g., a database maintained for a user account) may reside as an object within, e.g., a user account, which may also include one or more other objects (e.g., users, roles, privileges, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

A data platform (e.g., database system) can support data storage for one or more different organizations (e.g., customer organizations, which can be individual companies or business entities), where each individual organization can have one or more accounts (e.g., customer accounts) associated with the individual organizations, and each account can have one or more users (e.g., unique usernames or logins with associated authentication information). Additionally, an individual account can have one or more users that are designated as an administrator for the individual account. An individual account of an organization can be associated with a specific cloud platform (e.g., cloud-storage platform, such as such as AMAZON WEB SERVICES™ (AWS™), MICROSOFT® AZURE®, GOOGLE CLOUD PLATFORM™), one or more servers or data centers servicing a specific region (e.g., geographic regions such as North America, South America, Europe, Middle East, Asia, the Pacific, etc.), a specific version of a data platform, or a combination thereof. A user of an individual account can be unique to the account. Additionally, a data platform can use an organization data object to link accounts associated with (e.g., owned by) an organization, which can facilitate management of objects associated with the organization, account management, billing, replication, failover/failback, data sharing within the organization, and the like.

Traditional systems for large language models (LLMs) face significant deficiencies in terms of computational efficiency, memory usage, and scalability. One major inefficiency arises from the requirement to process every input and output token through all layers of the model.

Each layer contributes to the computation regardless of its actual impact on the output, resulting in unnecessary processing, particularly for tasks with long input prompts. In such scenarios, deeper layers often exhibit diminishing returns, producing outputs that are increasingly similar to those of their preceding layers. Despite this redundancy, traditional LLMs do not leverage layer-skipping or optimization techniques, leading to excessive computational costs.

Some traditional systems implement layer-skipping mechanisms, but these are applied uniformly to all tokens, both input and output, regardless of their specific processing needs. While this approach can reduce computational costs, this approach can lead to a degradation in output quality, particularly for tasks that require complex relationships between tokens to be modeled accurately. By skipping layers for all tokens, these systems fail to differentiate between the processing requirements of input tokens—where selective skipping can eliminate redundancy—and output tokens, which typically require the full depth of the model for high-quality generation. Additionally, these traditional skipping methods lack adaptability, treating all tasks and prompts uniformly, which limits their effectiveness for diverse applications and results in suboptimal performance in scenarios requiring nuanced context understanding or detailed outputs.

Another deficiency lies in the independent storage of Key-Value (KV) caches for each layer. During inference, the KV cache stores attention-related information, enabling the model to reference previous tokens efficiently.

However, in traditional LLMs, each layer's KV cache occupies significant GPU memory, which grows linearly with the number of layers and tokens. This memory burden severely limits the model's ability to handle long input sequences or large batch sizes, particularly in resource-constrained environments. As a result, tasks requiring extensive context often experience bottlenecks, with traditional systems unable to balance memory consumption and model performance effectively.

Moreover, traditional LLMs lack dynamic adaptability to the specific requirements of different tasks or inputs. For instance, all layers are engaged equally for both input and output token processing, regardless of the complexity of the input or the length of the output. This uniform treatment is particularly wasteful in applications where long prompts are paired with short outputs, such as summarization or question-answering tasks. The inability to adjust processing based on task characteristics further compounds inefficiencies, leading to slower inference speeds and higher operational costs.

Finally, traditional LLMs are not designed to optimize their architecture dynamically based on historical performance or data characteristics. They treat all prompts uniformly without considering variations in token length, linguistic context, or regional differences, which can lead to suboptimal processing. These rigid, one-size-fits-all models not only fail to maximize computational efficiency but also struggle to meet the diverse demands of real-world applications. Collectively, these deficiencies highlight the limitations of traditional systems in balancing resource efficiency, memory management, and adaptability to varied workloads.

Aspects of the present disclosure address the foregoing issues, among others, with a data platform, systems, methods, and devices that optimize the efficiency and scalability of LLM inference without compromising output quality. The platform modifies the LLM architecture to selectively skip the processing of specific layers for input tokens, focusing computation on the layers that provide the most meaningful contributions.

By skipping layers where outputs converge and add minimal new information, the data platform reduces computational overhead, particularly for tasks with long input prompts and short outputs. This targeted processing ensures that resources are allocated more effectively, addressing the inefficiencies of traditional systems.

To address memory usage, the data platform implements Key-Value (KV) cache merging, which consolidates the KV caches of adjacent layers into a single shared cache. This significantly reduces the memory footprint required during inference, enabling the model to handle longer input sequences or larger batch sizes.

By merging KV caches only for the layers that are skipped- or across other strategically selected layers—the data platform optimizes memory usage while maintaining the integrity of the attention mechanism. This enhancement directly overcomes the scalability limitations of traditional systems, making the platform suitable for resource-constrained environments and real-world applications.

Furthermore, the data platform dynamically adapts to task-specific requirements by tailoring its optimizations to the characteristics of the input. For example, in scenarios with long input prompts, the platform can aggressively skip deeper layers and apply KV cache merging, while for shorter prompts or more complex outputs, it can retain more layers for processing.

This adaptability ensures that the system balances computational efficiency and model accuracy, unlike traditional systems that treat all inputs uniformly. Additionally, the platform can create multiple modified LLMs with different layer-skipping and KV-merging configurations, train them using teacher-student distillation, and select the best-performing model for deployment, further refining the balance between efficiency and quality.

Finally, the platform leverages historical data to train and optimize models, allowing it to identify patterns in input characteristics, such as prompt length or linguistic context. This enables the development of customized LLM versions for specific tasks or regions, further enhancing performance and contextual accuracy. By combining layer-skipping, KV cache merging, and task-specific adaptability, the data platform transforms the traditional LLM framework into an efficient, scalable, and intelligent system tailored for diverse real-world demands.

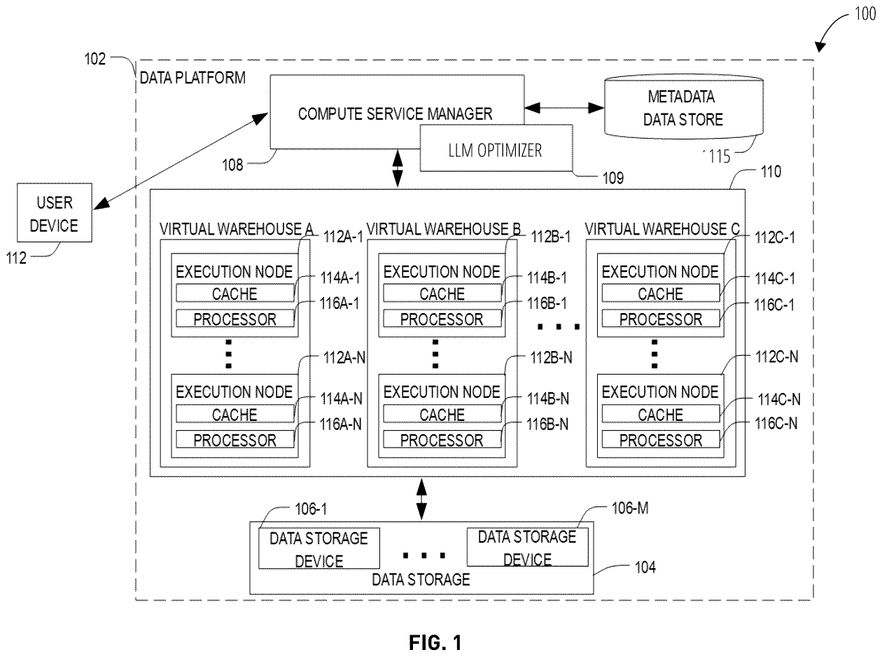

FIG. 1 illustrates an example computing environment 100 that includes a cloud data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the cloud data platform 102 comprises a three-tier architecture: a compute service manager 108 coupled to a metadata data store 115, an execution platform 110, and data storage 104. The cloud data platform 102 hosts and provides data access, management, reporting, and analysis services to multiple client accounts. Administrative users can create and manage identities (e.g., users, roles, and groups) and use permissions to allow or deny access to the identities to resources and services. The cloud data platform 102 is used for reporting and analysis of integrated data from one or more disparate sources including storage devices within the data storage 104. The data storage 104 comprises a plurality of computing machines and provides on-demand computer system resources such as data storage and computing power to the cloud data platform 102.

The compute service manager 108 includes multiple services that coordinate and manage operations of the cloud data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

As shown, the compute service manager 108 includes an LLM optimizer 109 that is responsible for selectively skipping processing in certain layers for input tokens, merging Key-Value (KV) caches across layers to reduce memory usage, and using teacher-student distillation to maintain output quality. Further details of the operation of the LLM optimizer 109 are discussed below.

The compute service manager 108 is also in communication with a user device 112. The user device 112 corresponds to a user of one of the multiple client accounts supported by the cloud data platform 102. In some implementations, the compute service manager 108 does not receive any direct communications from the user device 112 and only receives communications concerning jobs from a queue within the cloud data platform 102.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution nodes 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution nodes 112B-1 to 112B-N; execution node 112B-1 includes a cache 114B-1 and a processor 116B-1; and execution node 112B-N includes a cache 114B-N and a processor 116B-N. Additionally, virtual warehouse C includes execution nodes 112C-1 to 112C-N; execution node 112C-1 includes a cache 114C-1 and a processor 116C-1; and execution node 112C-N includes a cache 114C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the cloud data platform 102 based on the changing data storage/retrieval needs as well as the changing needs of the users and systems. The support of dynamic changes allows the cloud data platform 102 to scale quickly in response to changing demands on the systems and components within the cloud data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 115 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 115, execution platform 110, and data storage 104 are shown in FIG. 1 as individual discrete components. However, each of the compute service manager 108, metadata data store 115, execution platform 110, and data storage 104 may be implemented as a distributed system (e.g., distributed across multiple systems/platforms at multiple geographic locations). Additionally, each of the compute service manager 108, metadata data store 115, execution platform 110, and data storage 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

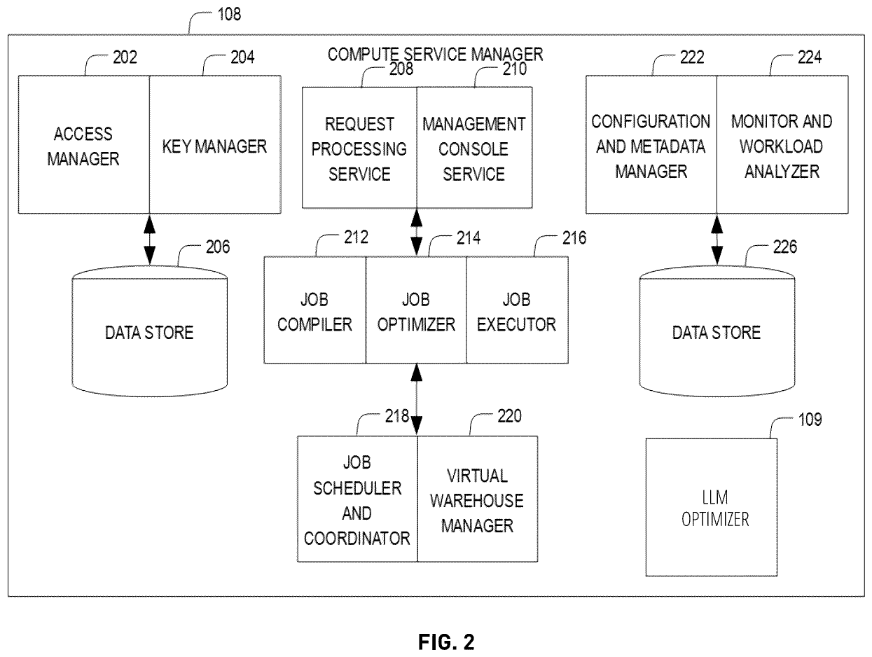

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the cloud data platform 102. For example, data store 226 may represent caches in execution platform 110, storage devices in data storage 104, the metadata data store 115, or any other storage device or system.

In addition, as mentioned above, the compute service manager 108 includes a LLM optimizer 109 that is responsible for selectively skipping processing in certain layers for input tokens, merging KV caches across layers to reduce memory usage, and using teacher-student distillation to maintain output quality. In some cases, distillation is performed as a preprocessing step prior to deployment. Further details regarding the functionality of the LLM optimizer 109 are discussed below.

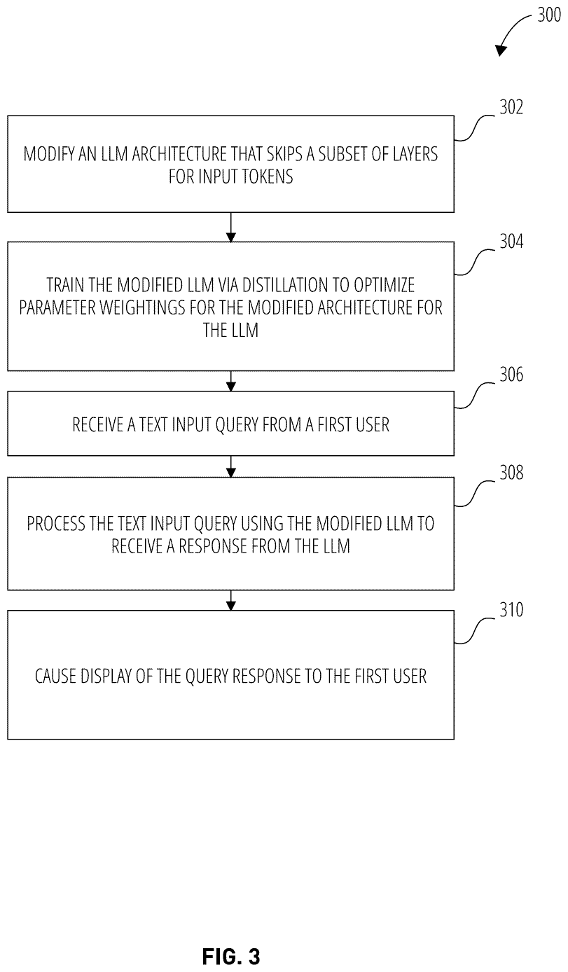

FIG. 3 illustrates an example method 300 for prefill optimization for LLM computations, according to some examples. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

FIG. 3 and the examples described throughout are described as being performed by certain systems or applying certain processes, such as a particular distillation machine learning model, but the processes described herein can be performed by one or more other or the same distillation machine learning models.

At block 302, the data platform modifies a large language model (LLM) to skip processing of a subset of layers for input tokens. The data platform can determine a modified architecture for the LLM that skips a subset of layers for input tokens of an LLM.

The data platform defines an altered structure of the LLM that specifies which layers will be skipped during the processing of input tokens. The goal is to reduce computational complexity while maintaining output quality.

In some cases, the data platform enables a user to select which layers to skip. In other cases, the data platform selectively skips certain layers. The data platform can skip certain layers based on prior knowledge or empirical studies of the LLM's behavior. Layers toward the deeper end of the architecture (closer to the output) are selected for skipping, as they often provide redundant or less significant contributions during input processing.

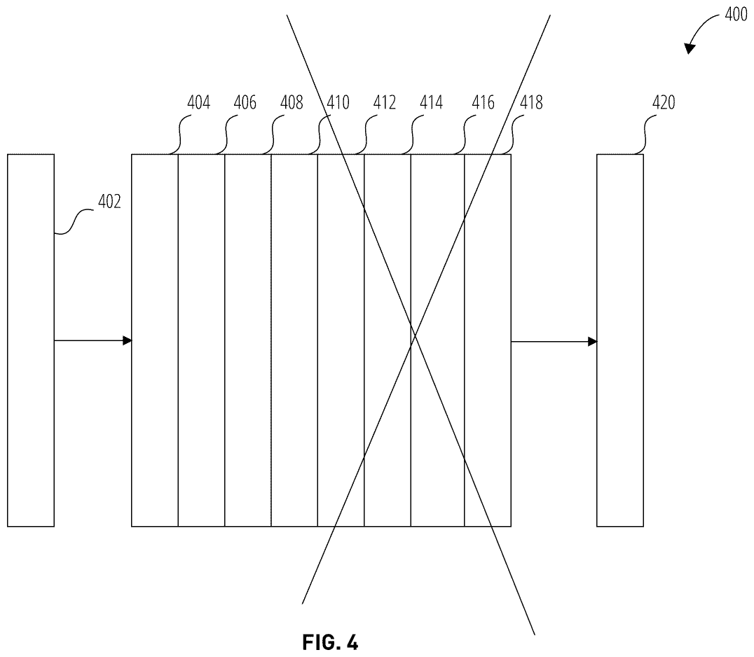

FIG. 4 is a diagram 400 illustrating the skipping of the second half of the hidden layers for input token processing for the LLM, according to some examples. The LLM comprises of an input layer 402, an output layer 420, and hidden layers 404, 406, 408, 410, 412, 414, 416, and 418. In this example, the second half of the layers 410, 412, 414, 416, and 418 may be skipped for input token processing while layers 404, 406, and 408 are retained.

The modified architecture adjusts the LLM's forward pass to skip the computational processing of certain layers for input tokens and use the outputs from an earlier layer to populate the Key-Value (KV) cache for the skipped layers, effectively bypassing their computation.

The data platform modifies the LLM to skip layers for input tokens while running all layers for output tokens by modifying the inference process of a large language model (LLM) to optimize computational efficiency. Typically, during inference, LLMs process input prompts (input tokens) through every layer in the model. The same process is repeated for each token generated as output (output tokens).

However, many enterprise tasks involve long input prompts and relatively shorter output sequences, making the input phase computationally expensive. By skipping layers for input tokens, the computational load is reduced, while still maintaining high-quality output by running the full model for output tokens. For input tokens, only a subset of layers is utilized. For instance, in an 8-layer transformer, the input tokens may be processed through just the first 4 layers, skipping the remaining layers.

The skipped layers' outputs are not calculated directly; instead, their Key-Value (KV) cache is prefilled using outputs from an earlier layer. This approach leverages the observation that deeper layers of a transformer often produce increasingly similar hidden states, making it possible to approximate their outputs without significant loss of quality. By bypassing the computation for skipped layers, the model substantially reduces the time and resources required to process long prompts. This approach is beneficial not only for long prompts but also for other scenarios (e.g., where the input tokens significantly outnumber the output tokens, such as a 100-input/10-output request, which can provide similar computational efficiency gains as in cases with 10,000-input/1,000-output sequences).

In contrast, for output tokens, the full model is used. Each output token is generated one at a time in an autoregressive manner, relying on the full stack of layers to attend to both the input tokens and the tokens already generated. Skipping layers during output token generation could lead to degraded quality, as every layer plays a critical role in capturing dependencies between tokens in the output sequence. For output tokens, the full model is used because each token is predicted from a vocabulary of tens to hundreds of thousands of possible tokens, making each token a significantly more complex task. Skipping layers during output token generation could compromise the model's ability to capture dependencies and nuances essential for accurate predictions, as every layer plays a critical role in handling such high-dimensional output spaces. To preserve the quality of the generated text, the LLM processes all layers during this phase, ensuring it fully leverages its capacity to model complex relationships and contextual nuances in the output.

Other variations in layer skipping can include selectively skipping either output tokens, both input and output tokens, or a combination of both, depending on the use case. Each variation has unique benefits and trade-offs that influence its applicability.

For instance, skipping layers for output tokens involves processing input tokens through all layers while reducing computation during the generation phase. This approach could work well for tasks with relatively simple or repetitive output sequences, such as structured data generation, where the contextual dependencies between output tokens may not require the full depth of the model.

For instance, skipping layers for output tokens can involve processing input tokens through all layers while reducing computation during the generation phase. This approach may work well for tasks with relatively simple or repetitive output sequences, such as structured data generation or text classification, where the model predicts from one of a few predefined classes rather than the entire vocabulary of tokens.

Skipping layers for both input and output tokens further reduces the overall computational cost, as fewer layers are engaged throughout the entire inference process. For example, earlier layers could be retained for initial processing, while skipping is applied more aggressively in deeper layers, where redundancies are more likely.

The data platform can skip the last several layers when processing input tokens because these layers often produce outputs that are increasingly similar for a given token between consecutive layers, or convergent. In contrast, the outputs of the earlier layers tend to capture more granular and varied features, which are critical for differentiating between input tokens and constructing meaningful intermediate representations.

As input tokens pass through deeper layers in the LLM, the hidden state outputs for a given token between consecutive layers become more similar. This occurs because deeper layers are optimized to refine and summarize the information from earlier layers, focusing on higher-level abstractions and relationships, while the hidden state outputs between different tokens remain varied.

The output of the later layers of the hidden state are often less distinct compared to earlier layers. This redundancy makes the computation in these layers less critical for processing input tokens, especially in tasks with long prompts.

The first few layers in an LLM are designed to extract fundamental features from the input, such as syntax, word embeddings, and local relationships between tokens. Skipping these layers would result in a loss of crucial foundational information needed to understand the input. Early layers tend to produce outputs that are more distinct, as they are focused on token-specific characteristics rather than aggregated global representations.

In some cases, the data platform skips the last half of the layers (e.g., layers 13-24 in a 24-layer transformer) for input token processing providing a balance between computational efficiency and model quality. This is because the first half of the layers adequately captures the essential input features, while the skipped layers contribute diminishing returns for input token differentiation.

For the skipped layers, the KV cache (Key-Value projections used in the attention mechanism) is populated using the output from the last processed layer (e.g., layer 12). This ensures that the model's later layers, though skipped during computation, still have sufficient information for inference during output token generation.

The data platform can modify the LLM to skip layers by defining a cutoff point within the model's architecture, where only a subset of layers is used for processing input tokens, and the remaining layers are skipped. For example, in a 24-layer transformer model, the first 12 layers might be retained to process input tokens, while layers 13-24 are bypassed.

This cutoff point can be predetermined based on empirical knowledge of the model or dynamically identified using similarity metrics that evaluate the redundancy in information across layers. The data platform leverages the observation that deeper layers often provide diminishing returns in terms of unique processing for input tokens.

To determine the cutoff point effectively, the platform can analyze the hidden states (intermediate representations) produced by adjacent layers of the LLM. This analysis can be conducted over a diverse set of prompts to ensure generalization. The hidden states are compared across consecutive layers to assess how similar the outputs are, and this similarity is used as a proxy to measure redundancy. If the hidden states from a later layer closely resemble those of the previous layer, it indicates that the deeper layer may not be adding significant new information for input token processing. This redundancy makes such layers ideal candidates for skipping.

Similarity metrics, such as cosine similarity, are commonly employed to quantify this overlap between hidden states. Cosine similarity measures the cosine of the angle between two vectors and outputs a value between −1 and 1, where higher values (closer to 1) indicate stronger alignment or similarity. By averaging these similarity scores across all tokens in a layer and aggregating them over thousands of prompts, the platform can identify patterns in how hidden states evolve through the layers. For instance, later layers (e.g., layers 13-24 in a 24-layer model) may consistently show high similarity with their preceding layers, indicating convergence and redundancy.

By relying on these similarity metrics, the platform can make data-driven decisions about which layers to skip. This ensures that the model retains its ability to process input tokens effectively while avoiding unnecessary computation. Moreover, using a statistical analysis across a large sample of prompts provides confidence that the selected cutoff point will generalize well to a wide range of tasks and inputs, making the approach robust and scalable. This method ensures that computational efficiency is achieved without compromising the model's overall accuracy and performance.

The data platform can dynamically and sequentially determine whether to skip specific hidden layers in a large language model (LLM) during inference, based on comparisons of outputs between adjacent layers. This approach allows the system to adaptively identify layers that contribute redundant or minimally different information. In some cases, this approach is feasible for only the output tokens, where predictions depend on a single token at a time, and not the input tokens.

By analyzing the similarity between the outputs of a current hidden layer and its preceding layer, the data platform establishes whether the current layer provides unique contributions. If the difference is determined to be below a predefined threshold, the current layer is skipped to optimize computational efficiency.

The data platform can calculate the difference between the outputs of the current hidden layer and the previous layer and check whether this difference falls within a specified range (the threshold). When the difference is within the threshold, it signals that the two layers are producing similar results, and the current hidden layer is skipped.

This comparison ensures that skipping occurs only when it does not compromise the quality of the output. For example, layers closer to the model's output (e.g., the last hidden layer) are more likely to be redundant in some contexts, especially after analyzing token dependencies.

The data platform can perform sequential comparisons with prior layers to further refine the skipping process. If the last hidden layer is skipped, the system proceeds to evaluate its preceding layers (e.g., the second-to-last hidden layer), comparing each layer's output to its predecessor. This sequence continues until the system identifies a layer that contributes significantly different information and decides to retain it. This layered approach ensures that redundant computations are minimized without sacrificing the model's capacity to generate accurate outputs. By dynamically assessing the importance of each layer, the data platform achieves a balance between computational efficiency and output quality, especially in scenarios where deeper layers converge and provide diminishing returns.

At block 304, the data platform trains the modified LLM via distillation to optimize parameter weightings for the modified architecture for the LLM. Once the architecture is modified, the LLM undergoes a distillation process to optimize its parameter weightings for the new structure. This step ensures that the model can maintain its predictive accuracy despite the skipped layers.

The unmodified original LLM can serve as the teacher model and generates output logits (probabilities for token predictions) based on the same input prompts. These logits represent the desired behavior of the modified LLM.

The modified LLM is the student model, trained to replicate the teacher model's output behavior despite its altered architecture. By comparing its predictions to the teacher's logits, the student learns to adjust its parameter weightings.

The distillation loss function minimizes the difference between the teacher model's output logits and the student model's predictions. A temperature scaling parameter may be applied to smooth the logits, facilitating more effective learning.

In some cases, specific parameters, such as the Key (K), Value (V), and/or Query (Q) projection weights of the skipped layers, are updated during distillation. This reduces the computational cost of training. This targeted approach can also avoid disrupting the weights of the rest of the model, which helps preserve overall accuracy and performance.

Returning to FIG. 3, at block 306, the data platform receives a text input query from a first user. The data platform can receive, from a user, an interactive request via a communication interface of a data platform, the interactive request comprising a question requesting a response from the communication interface. The user can be engaging with the platform through a communication interface, such as a chat window in a web-based chat interface, a messaging application, a voice assistant interface, and/or the like.

This interaction can occur in real-time, where the user expects a quick, interactive response from the platform. The interface can capture the user's input and identify whether the input includes simple text to more complex requests.

The data platform initiates a chat message comprising a user interface configured to receive prompts from a first user. The data platform initiates display of the interactive component through which users can input their queries or commands, allowing the system to interact with the users effectively. In some cases, the interactive component can include a user-facing GUI or an API used by another software component.

The UI is configured to receive multiple types of inputs from the user. These inputs can include text queries, commands, voice inputs, or the like depending on the configuration of the data platform. The platform manages user sessions and prompts to maintain context throughout the interaction. This includes tracking the history of prompts and responses, enabling a seamless conversational flow.

The UI includes an input field where users can type their queries or commands. This field may include features such as autocomplete suggestions and error correction to enhance user experience. Autocomplete suggestions help users by predicting the rest of their query as they type, speeding up the input process and reducing errors. The data platform can maintain a database of commonly asked questions and phrases relevant to the domain of the chat application. This database can be built from historical data of similar users or the particular user, or designed based on anticipated user needs.

In some embodiments, the data platform uses predictive text algorithms that analyze the initial characters typed by the user and match them with the most likely completions from the database. These predictive text algorithms can leverage machine learning models trained on a large corpus of text to improve prediction accuracy. The data platform can execute real-time processing to provide suggestions instantly as the user types.

The user interface can include an area where responses generated by the system are displayed. This area updates dynamically as the conversation progresses. The user interface can include interaction buttons for common actions such as submitting a query, clearing the input field, or accessing help and support.

The data platform can receive a plurality of prompts from the user, the plurality of prompts comprising a first query. The data platform is designed to handle multiple user inputs, or “prompts,” that collectively form a history of queries from the user. The data platform maintains a session for each user, tracking the sequence of prompts within a conversation.

The series of prompts provided by the user give context to subsequent prompts. Each prompt is stored in a database or in-memory data structure, indexed by session ID and timestamp. This ensures that the order of prompts is preserved, which is essential for understanding context.

As the user enters prompts, the system processes each one in real-time, appending the latest prompt to the current session's context. This immediate processing allows for dynamic interactions and adjustments based on new inputs. As an example, if a user is interacting with a financial data platform and the user's prompts are as follows: Prompt 1: “Show me the quarterly earnings for Q1 2023.” Prompt 2: “How does this compare to the previous quarter?” Prompt 3: “And what about the same quarter last year?” In this example, the data platform receives three prompts that collectively provide context for a more comprehensive query about quarterly earnings and their comparisons over different periods.

The data platform assesses prompts to identify a query. In some embodiments, the data platform also categorizes the prompts. This categorization process helps the data platform to determine whether the prompt requires data retrieval from a third-party dataset or if the prompt can be responded to by an LLM directly.

For example, the data platform classifies the prompts into three distinct categories. The first category can include a conversational prompt that do not require any search or retrieval from an indexed database. For instance, greetings or simple expressions of courtesy fall into this category. When a prompt is categorized as such a pleasantry, the data platform can immediately request an LLM to provide a quick and fast response, ensuring a seamless conversational flow without unnecessary delays.

Prompt categories can include a dataset-specific question, where these prompts specifically ask for information that needs to be retrieved from a database. For example, if a user queries specific data points or trends within a dataset, the system recognizes the need for database retrieval to generate an accurate response. In this case, the system initiates the necessary search processes, as further described herein, to fetch the relevant data from the indexed tables or databases.

Prompt categories can include questions on metadata, where this category includes queries about the dataset's metadata or general knowledge about the data. For example, if a user asks about the type of data available or how to interact with the dataset, the system categorizes such prompts as a metadata question. This type of prompt involves providing information about the dataset's structure, available fields, or how to perform specific queries, and as such, initiates the necessary search processes, as further described herein.

To efficiently handle this categorization, the data platform can apply a separate machine learning model, such as a smaller LLM, which specializes in classifying prompts into these categories. By leveraging this categorization step, the data platform can quickly determine the appropriate action for each prompt. If a prompt is classified as a pleasantry, the system can bypass the search index and directly generate a response using the LLM. For dataset-specific questions and metadata inquiries, the system proceeds with the document or text retrieval processes as described herein, ensuring that users receive accurate and relevant information based on their queries.

At block 308, the data platform processes the text input query using the modified LLM to receive a response from the LLM. The data platform leverages the optimizations introduced in earlier stages, such as the skipping of layers for input tokens.

The text input query is first tokenized, converting the text into a sequence of discrete tokens (e.g., words, subwords, or characters), which the LLM can understand. These tokens are represented numerically using embeddings that capture semantic and syntactic relationships.

The tokenized query is passed through the modified architecture of the LLM. For input tokens, only a subset of layers is used, as determined during the modification process (e.g., the first half of the layers in a 24-layer model). Skipped layers' outputs are approximated using the Key-Value (KV) cache populated by earlier layers, reducing computational complexity without compromising continuity. This optimization significantly reduces the time and resources required to process long input queries.

After processing the input tokens, the LLM generates output tokens one at a time in an autoregressive manner. During this phase, the full stack of layers is utilized to ensure high-quality generation. Each new token is influenced by both the processed input tokens and previously generated output tokens.

For every token generation step, the model queries the KV cache to efficiently attend to relevant parts of the input and prior outputs.

At block 310, the data platform displays the query response to the first user. Once all output tokens are generated, they are combined and decoded back into human-readable text. This response is then formatted and sent back to the system for further processing or directly to the user interface for display.

By processing the input query with the modified LLM, the data platform achieves an efficient balance between computational cost and output quality, making the system well-suited for tasks requiring long input queries and concise, high-accuracy outputs, such as summarization, translation, or question-answering.

In certain examples, instead of skipping entire layers, the data platform can selectively skip specific nodes (individual components or neurons) within a layer. This finer-grained approach leverages the observation that some nodes in a layer may contribute minimally to the output while others carry critical information. By skipping only the less significant nodes, the system retains much of the computational savings achieved by skipping entire layers while preserving the layer's overall utility and minimizing potential loss of quality.

This selective skipping can be guided by analyzing the importance of individual nodes within a layer. For example, the data platform can perform node activation analysis where nodes with consistently low activation values across a range of inputs may indicate they contribute little to the layer's output and can be skipped without significant loss of information.

The data platform can perform gradient-based decisioning, where gradients associated with specific nodes during training or inference can reveal their impact on the model's output. Nodes with near-zero gradients may be less influential and suitable for skipping. The data platform can perform attention decisioning, where in attention-based architectures, nodes contributing less to attention scores for relevant tokens can be deprioritized or skipped entirely.

By skipping certain nodes, the system can reduce computational overhead within a layer without bypassing the entire layer's structure. This allows the layer to process input features more comprehensively than if it were entirely skipped, making this approach particularly useful in tasks where some layers have a mix of high- and low-impact nodes. Additionally, this technique can complement layer-skipping strategies, offering a hierarchical optimization method where both nodes and layers are selectively omitted to balance efficiency and accuracy.

The data platform can introduce additional flexibility in modifying the LLM by enabling the skipping of a subset of nodes within both unskipped and skipped layers. For unskipped layers, this allows certain nodes that contribute minimally to the layer's output to be bypassed while retaining the computational benefits of node-specific optimizations.

For skipped layers, instead of bypassing the entire layer, only a subset of its nodes is skipped, ensuring that critical nodes continue processing. This node-level granularity provides a refined approach to layer skipping, balancing computational efficiency with the preservation of key features and outputs, thereby maintaining model performance while reducing resource usage.

Prompts can be categorized or split based on various characteristics such as length, content type, or geographic and linguistic features. By analyzing historical training data, the system can identify patterns in the types of prompts it encounters and create specialized versions of the LLM optimized for these distinct categories.

For instance, prompts can be classified as long or short based on their token count, with separate versions of the model designed to handle each effectively. A model optimized for long prompts may use techniques like aggressive layer skipping for input tokens to reduce computational overhead, whereas a model for short prompts may retain more layers for detailed processing.

Prompts can also be categorized geographically or linguistically. For example, prompts originating from different regions often exhibit unique characteristics, such as language, dialect, or topic preferences. By segmenting training data geographically, models can be fine-tuned for specific regions or languages, improving accuracy and contextual relevance. For instance, a model fine-tuned for prompts from Japan may better handle nuances in Japanese language and culture, while a model for North America might prioritize English and regional idioms.

Categorizing prompts based on their characteristics enables the development of customized LLMs that are more efficient and contextually accurate. These specialized models can handle specific use cases, languages, or content types with optimized architectures, such as tailored layer-skipping strategies or different parameter configurations. This segmentation not only improves performance but also allows enterprises to deploy the most appropriate model for the context, reducing resource consumption and enhancing user experience.

In some cases, the data platform creates multiple modified LLMs by designing variations of the original model with different configurations for skipping layers. Each modified LLM skips a distinct number or combination of layers to explore the trade-offs between computational efficiency and performance quality.

For instance, in a 24-layer model, one modified version may skip the last 6 layers, another may skip the last 12 layers, and a third may skip a mix of middle and deep layers. These configurations are chosen to evaluate how each impacts the model's ability to process input tokens while maintaining accurate and meaningful outputs.

Once these modified LLMs are created, they are individually trained using distillation. In the distillation process, the original unmodified LLM acts as the “teacher” model, generating high-quality outputs for various training prompts. Each modified LLM, or “student,” learns to replicate the teacher's outputs despite its architectural modifications. The training focuses on optimizing the parameter weightings of the student models while accounting for the skipped layers. This ensures that the student models recover any potential loss of predictive capability caused by the architectural changes.

After training, the data platform tests the performance of each modified LLM across a range of tasks and datasets. Metrics such as accuracy, latency, throughput, and resource utilization can be analyzed to determine the effectiveness of each configuration.

The system identifies the best-performing model by balancing computational efficiency (e.g., reduced latency or GPU memory usage) and output quality. The selected modified LLM is then deployed during inference, ensuring the model optimally meets the application's requirements while minimizing resource consumption. This iterative testing and selection process ensures that the most suitable version of the LLM is used for real-world scenarios.

Systems and methods described herein include training a machine learning network, such as training to optimize a large language model (LLM) for efficient inference by selectively skipping processing of a subset of layers during input token processing. The machine learning network can be trained to identify which layers or nodes within the LLM can be skipped for certain types of inputs, such as long prompts, while maintaining high output quality. The model can also be trained to determine optimal architectures based on historical training data, which include input sequences, processing characteristics, and resulting model outputs, allowing the LLM to make efficient inferences on new inputs.

Training of the modified LLM is necessarily rooted in computer technology and improves inference technology by using layer-skipping strategies to reduce computational costs while preserving performance. For example, new inputs such as text queries or prompts can be processed using the modified LLM to generate responses efficiently. The training process leverages historical data to optimize the LLM for specific configurations, such as skipping a predefined subset of layers or nodes based on token or prompt characteristics. These modifications enable the LLM to adapt dynamically to new and unseen inputs while maintaining the quality of predictions.

Such training involves complex computational processes, typically requiring iterative adjustments to model parameters via forward and backward propagation of training data. Input data, including prompts and expected outputs, are used to optimize the model through teacher-student distillation, enabling the modified LLM to mimic the outputs of the original unmodified model. This training framework supports machine learning algorithms that allow the modified LLM to process long prompts with fewer layers, apply layer-skipping strategies efficiently, and achieve higher throughput while reducing computational demands. The described methods improve LLM performance by minimizing false positives (e.g., degraded output quality) and maximizing efficiency in real-world applications.

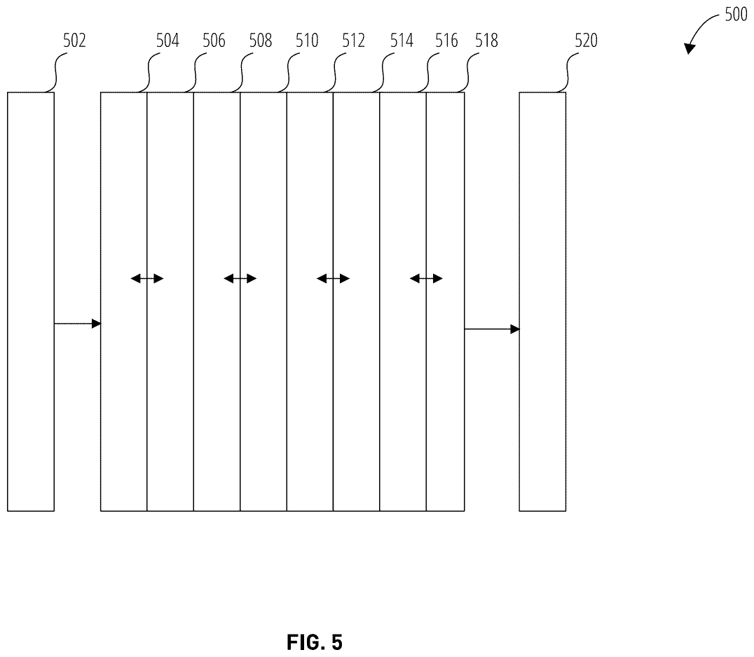

FIG. 5 is an architectural diagram 500 illustrating merging of layers, according to some examples. FIG. 5 includes an input layer 502, hidden layers 504, 506, 508, 510, 512, 514, 516, 518, and an output layer 520.

The data platform can merge Key-Value (KV) caches to reduce the memory overhead of LLMs while retaining their ability to generate accurate and high-quality outputs. In the architecture illustrated in FIG. 5, where we have an input layer (502), multiple hidden layers (504-518), and an output layer (520), KV caches are merged between specific layers to conserve GPU memory usage. This approach complements layer skipping by enabling longer prompts and parallel processing while ensuring the system remains efficient and scalable.

In the example of FIG. 5 where every two layers are merged, Layers 504 and 506 are paired and their KV caches are merged. Similarly, layers 508 and 510, 512 and 514, and so on, are merged. This grouping ensures that memory usage is halved for these layers, as the KV cache for two layers is stored as a single merged cache instead of individual caches for each layer.

Each layer in a transformer computes a Key (K) and Value (V) matrix during the attention mechanism. These KV matrices are stored in the KV cache and used to compute attention scores for subsequent tokens during inference. The data platform can combine the KV caches for two layers, such that their values are aggregated and stored as a single cache. This can be done in several ways:
Averaging: The KV matrices for the two layers are averaged. For example, the merged KV cache for layers 504 and 506 would be:

$${K}_{merged} = \frac{{K}_{504} + {K}_{506}}{2} , {V}_{merged} = \frac{{V}_{504} + {V}_{506}}{2} .$$

$$Kmerged = 2 K 504 + K 5 \; 06 , Vmerged = 2 V 504 + V 5 6.$$

Weight Copying: Instead of averaging, the KV cache from one of the layers (e.g., 506) is copied over to represent both layers. This simplifies computation and reduces merging time.
Fractional Merging: Only specific weights or portions of the KV matrices (e.g., attention heads or critical nodes) are merged to retain essential information while saving memory.

In some cases, the combining of the KV caches can be applied after the KV caches are already generated and then merged post-generation. The data platform can simplify the process by generating a merged KV cache directly during computation, avoiding the need for post-processing and further reducing computational overhead. This approach streamlines the merging process and enhances efficiency.

During inference, both layers in the merged pair (e.g., 504 and 506) use the same merged KV cache. This means when layer 504 queries the cache, it uses K_{merged} Kmerged and V_{merged} Vmerged. Similarly, when layer 506 processes tokens, it also references K_{merged} Kmerged and V_{merged} Vmerged. This shared access reduces memory usage without requiring duplicate computation.

Instead of merging every two layers, other configurations can be used. For example, the first five layers could be merged into one group, followed by groups of three layers, and then two layers. This strategy allows for smaller caches in early layers (where token-specific differences are significant) and larger caches in deeper layers (where representations converge).

The data platform can merge smaller groups near the input layer (e.g., merging one or two layers) and larger groups near the output layer (e.g., merging three or four layers) to balance memory savings with output quality. Specific nodes or attention heads critical to KV computation can be preserved, while others are merged.

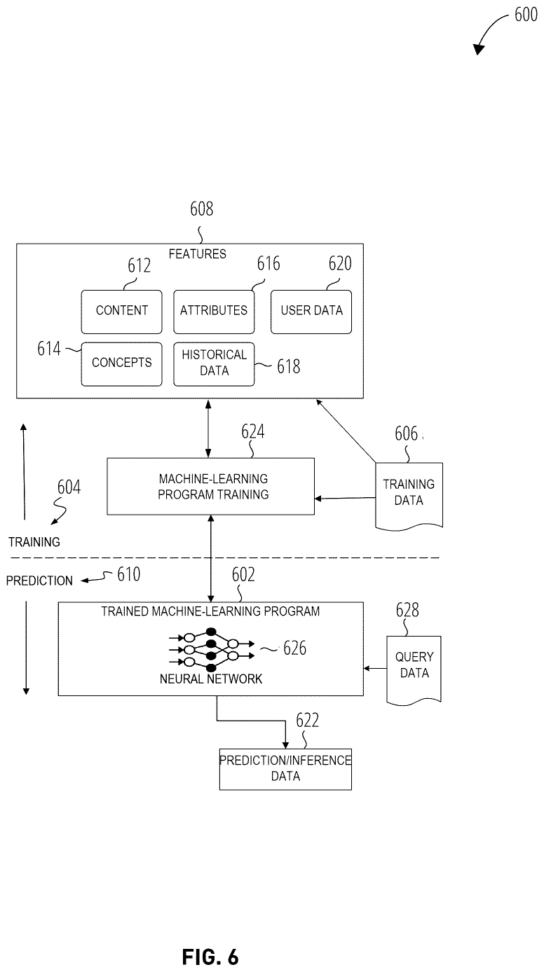

FIG. 6 illustrates further details of two example phases, namely a training phase 604 (e.g., part of the model selection and training 706) and a prediction phase 610 (part of prediction 710). Prior to the training phase 604, feature engineering 704 is used to identify features 608. This may include identifying informative, discriminating, and independent features for effectively operating the trained machine-learning program 602 in pattern recognition, classification, and regression. In some examples, the training data 606 includes labeled data, known for pre-identified features 608 and one or more outcomes. Each of the features 608 may be a variable or attribute, such as an individual measurable property of a process, article, system, or phenomenon represented by a data set (e.g., the training data 606). Features 608 may also be of different types, such as numeric features, strings, and graphs, and may include one or more of content 612, concepts 614, attributes 616, historical data 618, and/or user data 620, merely for example.

In training phase 604, the machine-learning pipeline 600 uses the training data 606 to find correlations among the features 608 that affect a predicted outcome or prediction/inference data 622.

With the training data 606 and the identified features 608, the trained machine-learning program 602 is trained during the training phase 604 during machine-learning program training 624. The machine-learning program training 624 appraises values of the features 608 as they correlate to the training data 606. The result of the training is the trained machine-learning program 602 (e.g., a trained or learned model).

Further, the training phase 604 may involve machine learning, in which the training data 606 is structured (e.g., labeled during preprocessing operations). The trained machine-learning program 602 implements a neural network 626 capable of performing, for example, classification and clustering operations. In other examples, the training phase 604 may involve deep learning, in which the training data 606 is unstructured, and the trained machine-learning program 602 implements a deep neural network 626 that can perform both feature extraction and classification/clustering operations.

In some examples, a neural network 626 may be generated during the training phase 604 and implemented within the trained machine-learning program 602. The neural network 626 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 626 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 626 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 604, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 610, the trained machine-learning program 602 uses the features 608 for analyzing query data 628 to generate inferences, outcomes, or predictions, as examples of a prediction/inference data 622. For example, during prediction phase 610, the trained machine-learning program 602 generates an output. Query data 628 is provided as an input to the trained machine-learning program 602, and the trained machine-learning program 602 generates the prediction/inference data 622 as output, responsive to receipt of the query data 628.

In some examples, the trained machine-learning program 602 may be a generative AI model. Generative AI is a term that may refer to any type of artificial intelligence that can create new content from training data 606. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like.

For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 622 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, extensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a cloud data platform 102 can include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A cloud data platform 102 may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a cloud data platform 102, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

In the present disclosure, physical units of data that are stored in a cloud data platform—and that make up the content of, e.g., database tables in customer accounts (e.g., customer users)—are referred to as micro-partitions. In different implementations, a cloud data platform can store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the cloud data platform, a given file is referred to herein as an “internal file” and may be stored in (or at, or on, etc.) what is referred to herein as an “internal storage location.” If stored external to the cloud data platform, a given file is referred to herein as an “external file” and is referred to as being stored in (or at, or on, etc.) what is referred to herein as an “external storage location.”

While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

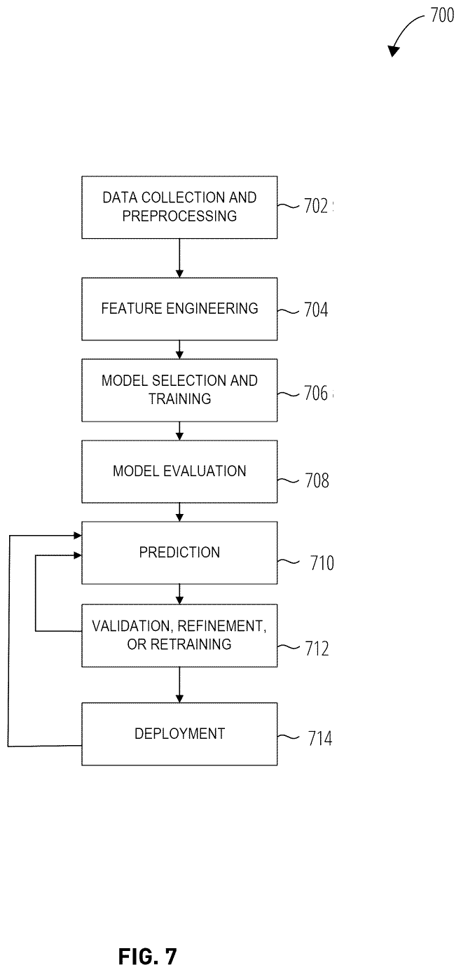

FIG. 7 depicts a machine-learning pipeline 700 and FIG. 7 illustrates training and use of a machine-learning program (e.g., model) 600. Specifically, FIG. 7 is a flowchart depicting a machine-learning pipeline 700, according to some examples. The machine-learning pipeline 700 can be used to generate a trained model, for example the trained machine-learning program 602 of FIG. 6, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include linear regression, decision trees, and neural networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 604 as described and depicted in connection with FIG. 7, generating a trained machine-learning program 602 may include multiple phases that form part of the machine-learning pipeline 700, including for example the following phases illustrated in FIG. 7: data collection and preprocessing 702, feature engineering 704, model selection and training 706, model evaluation 708, prediction 710, validation, refinement, or retraining 712, and deployment 714, or a combination thereof.

For example, data collection and preprocessing 702 can include a phase for acquiring and cleaning data to ensure that it is suitable for use in the machine learning model. This phase may also include removing duplicates, handling missing values, and converting data into a suitable format. Feature engineering 704 can include a phase for selecting and transforming the training data 606 to create features that are useful for predicting the target variable. Feature engineering may include (1) receiving features 608 (e.g., as structured or labeled data in supervised learning) and/or (2) identifying features 608 (e.g., unstructured, or unlabeled data for unsupervised learning) in training data 606. Model selection and training 706 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 708 can include a phase for evaluating the performance of a trained model (e.g., the trained machine-learning program 602) on a separate testing dataset. This phase can help determine if the model is overfitting or underfitting and determine whether the model is suitable for deployment. Prediction 710 can include a phase for using a trained model (e.g., trained machine-learning program 602) to generate predictions on new, unseen data. Validation, refinement or retraining 712 can include a phase for updating a model based on feedback generated from the prediction phase, such as new data or user feedback. Deployment 714 can include a phase for integrating the trained model (e.g., the trained machine-learning program 602) into a more extensive system or application, such as a web service, mobile app, or IoT device. This phase can involve setting up APIs, building a user interface, and ensuring that the model is scalable and can handle large volumes of data.

In view of the disclosure above, various examples are set forth below. It should be noted that one or more features of an example, taken in isolation or combination, should be considered within the disclosure of this application.

Example 1 is a computer system comprising: at least one hardware processor; and at least one memory storing instructions that cause the at least one hardware processor to perform operations comprising: modifying a large language model (LLM) to skip processing of a subset of layers for input tokens by: determining a modified architecture for the LLM that skips the subset of layers; and training the modified LLM via distillation to configure parameter weightings for the modified architecture for the LLM; receiving a text input query from a first user; processing the text input query using the modified LLM to receive a response from the LLM; and causing display of the query response to the first user.

In Example 2, the subject matter of Example 1 includes, wherein to skip the processing of the subset of layers comprise adjusting a forward pass of the LLM to skip the computational processing of the subset of layers and to use outputs from an earlier layer to populate a Key-Value (KV) cache for the skipped layers.

In Example 3, the subject matter of Examples 1-2 includes, wherein the modified LLM processes all of the layers corresponding to output tokens for the LLM.

In Example 4, the subject matter of Examples 1-3 includes, wherein modifying the LLM further comprises skipping processing of another subset of layers for output tokens of the LLM.

In Example 5, the subject matter of Examples 1-4 includes, wherein the operations further comprise comparing an output of a current hidden layer with an output of a previous hidden layer to determine whether to skip the current hidden layer in the skipping of the subset of layers.

In Example 6, the subject matter of Example 5 includes, wherein comparing the output of the current hidden layer with the output of the previous hidden layer comprises determining whether a difference between the output of the current hidden layer and the output of the previous hidden layer is within a threshold, and in response to determining that the difference is within the threshold, skipping the current hidden layer.

In Example 7, the subject matter of Examples 5-6 includes, wherein the current hidden layer is the last hidden layer adjacent to the output layer, wherein the operations further comprise, in response to determining to skip the current hidden layer: repeatedly and sequentially comparing prior layers to the last hidden layer with previous layers of individual prior layers to determine whether to skip the prior layers until one of the prior layers are not skipped.

In Example 8, the subject matter of Examples 5-7 includes, wherein comparing the output of the current hidden layer with the output of the previous hidden layer comprises generating a first number representative of the outputs to nodes of the current hidden layer and a second number representative of the outputs to the nodes of the previous hidden layer using cosine similarity.

In Example 9, the subject matter of Examples 1-8 includes, wherein training the modified LLM comprises performing distillation on the modified LLM by comparing outputs of the modified LLM that is set as a student model with outputs of the original unmodified LLM set as a teacher model to reduce differences between the student model and the teacher model.

In Example 10, the subject matter of Examples 1-9 includes, wherein modifying the LLM further comprises skipping a subset of nodes of an unskipped layer.

In Example 11, the subject matter of Examples 1-10 includes, wherein skipping processing of the subset of layers comprises skipping a subset of nodes of a skipped layer.

In Example 12, the subject matter of Examples 1-11 includes, wherein modifying the LLM is based on a length characteristic of a prompt or query such that multiple modified LLMs are generated for certain prompt or query lengths.

In Example 13, the subject matter of Examples 1-12 includes, wherein the operations further comprise modifying the LLM based on a geographic location of users, such that multiple modified LLMs are generated for certain geographic locations.

In Example 14, the subject matter of Examples 1-13 includes, wherein modifying the LLM comprises generating multiple modified versions of the LLM, each modified version skipping a different subset of layers, and training each modified version using a teacher-student distillation process to enhance parameter weightings for the respective modified architecture.

In Example 15, the subject matter of Example 14 includes, wherein the operations further comprise testing the performance of each modified version of the LLM using one or more predefined metrics, and selecting a modified version of the LLM for deployment during inference based on a balance between computational efficiency and output quality as determined by the predefined metrics.

In Example 16, the subject matter of Examples 1-15 includes, wherein modifying the LLM further comprises merging Key-Value (KV) caches of hidden layers in groups to reduce memory usage during inference.

In Example 17, the subject matter of Example 16 includes, wherein merging the KV caches is applied to the same subset of layers that are skipped during input token processing.

In Example 18, the subject matter of Examples 16-17 includes, wherein merging the KV caches comprises merging smaller groups of layers near the input layer and larger groups of layers near the output layer.

Example 19 is a method performed by at least one hardware processor, the method comprising: modifying a large language model (LLM) to skip processing of a subset of layers for input tokens by: determining a modified architecture for the LLM that skips the subset of layers; and training the modified LLM via distillation to configure parameter weightings for the modified architecture for the LLM; receiving a text input query from a first user; processing the text input query using the modified LLM to receive a response from the LLM; and causing display of the query response to the first user.

In Example 20, the subject matter of Example 19 includes, wherein to skip the processing of the subset of layers comprise adjusting a forward pass of the LLM to skip the computational processing of the subset of layers and to use outputs from an earlier layer to populate a Key-Value (KV) cache for the skipped layers.

In Example 21, the subject matter of Examples 19-20 includes, wherein the modified LLM processes all of the layers corresponding to output tokens for the LLM.

In Example 22, the subject matter of Examples 19-21 includes, wherein modifying the LLM further comprises skipping processing of another subset of layers for output tokens of the LLM.

In Example 23, the subject matter of Examples 19-22 includes, wherein the method comprises comparing an output of a current hidden layer with an output of a previous hidden layer to determine whether to skip the current hidden layer in the skipping of the subset of layers.

In Example 24, the subject matter of Examples 19-23 includes, wherein training the modified LLM comprises performing distillation on the modified LLM by comparing outputs of the modified LLM that is set as a student model with outputs of the original unmodified LLM set as a teacher model to reduce differences between the student model and the teacher model.

In Example 25, the subject matter of Examples 19-24 includes, wherein modifying the LLM further comprises skipping a subset of nodes of an unskipped layer.

In Example 26, the subject matter of Examples 19-25 includes, wherein skipping processing of the subset of layers comprises skipping a subset of nodes of a skipped layer.

In Example 27, the subject matter of Examples 19-26 includes, wherein modifying the LLM is based on a length characteristic of a prompt or query such that multiple modified LLMs are generated for certain prompt or query lengths.

In Example 28, the subject matter of Examples 19-27 includes, wherein the operations further comprise modifying the LLM based on a geographic location of users, such that multiple modified LLMs are generated for certain geographic locations.

In Example 29, the subject matter of Examples 19-28 includes, wherein modifying the LLM comprises generating multiple modified versions of the LLM, each modified version skipping a different subset of layers, and training each modified version using a teacher-student distillation process to enhance parameter weightings for the respective modified architecture.

Example 30 is computer-storage media comprising instructions that, when executed by one or more processors of a machine, configure the machine to perform operations comprising: modifying a large language model (LLM) to skip processing of a subset of layers for input tokens by: determining a modified architecture for the LLM that skips the subset of layers; and training the modified LLM via distillation to configure parameter weightings for the modified architecture for the LLM; receiving a text input query from a first user; processing the text input query using the modified LLM to receive a response from the LLM; and causing display of the query response to the first user.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

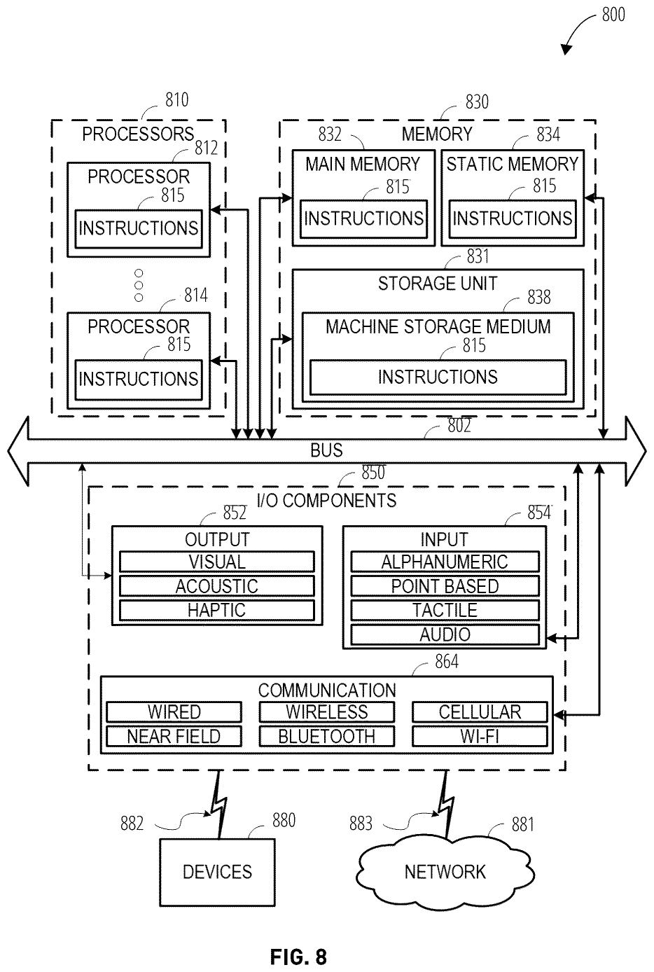

FIG. 8 ILLUSTRATES A DIAGRAMMATIC REPRESENTATION OF A MACHINE 800 IN THE FORM OF A COMPUTER SYSTEM WITHIN WHICH A SET OF INSTRUCTIONS MAY BE EXECUTED FOR CAUSING THE MACHINE 800 TO PERFORM ANY ONE OR MORE OF THE METHODOLOGIES DISCUSSED HEREIN, ACCORDING TO AN EXAMPLE EMBODIMENT. SPECIFICALLY, FIG. 8 SHOWS A DIAGRAMMATIC REPRESENTATION OF THE MACHINE 800 IN THE EXAMPLE FORM OF A COMPUTER SYSTEM, WITHIN WHICH INSTRUCTIONS 815 (E.G., SOFTWARE, A PROGRAM, AN APPLICATION, AN APPLET, AN APP, OR OTHER EXECUTABLE CODE), FOR CAUSING THE MACHINE 800 TO PERFORM ANY ONE OR MORE OF THE METHODOLOGIES DISCUSSED HEREIN, MAY BE EXECUTED. FOR EXAMPLE, THE INSTRUCTIONS 815 MAY CAUSE THE MACHINE 800 TO IMPLEMENT PORTIONS OF THE DATA FLOWS DESCRIBED HEREIN. IN THIS WAY, THE INSTRUCTIONS 815 TRANSFORM A GENERAL, NON-PROGRAMMED MACHINE INTO A PARTICULAR MACHINE 800 (E.G., THE CLIENT DEVICE 112 OF FIG. 1, THE COMPUTE SERVICE MANAGER 108 OF FIG. 1, THE EXECUTION PLATFORM 110 OF FIG. 1) THAT IS SPECIALLY CONFIGURED TO CARRY OUT ANY ONE OF THE DESCRIBED AND ILLUSTRATED FUNCTIONS IN THE MANNER DESCRIBED HEREIN.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 815, sequentially or otherwise, that specify actions to be taken by the machine 800. Further, while only a single machine 800 is illustrated, the term “machine” shall also be taken to include a collection of machines 800 that individually or jointly execute the instructions 815 to perform any one or more of the methodologies discussed herein.

The machine 800 includes processors 810 (such as processor 812 and processor 814), memory 830, and input/output (I/O) I/O components 850 (including output components 852 and input components 854) configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 815. The term “processor” is intended to include multi-core processors 810 that may comprise two or more independent processors (sometimes referred to as “cores”) that may execute instructions 815 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 831, all accessible to the processors 810 such as via the bus 802. The main memory 832, the static memory 834, and the storage unit 831 comprise a machine storage medium 838 that may store the instructions 815 embodying any one or more of the methodologies or functions described herein. The instructions 815 may also reside, completely or partially, within the main memory 832, within the static memory 834, within the storage unit 831, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines, such as mobile phones, will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine machine 800 to a network 881 via a coupler 883 or to devices 880 via a coupling 882. For example, the communication components 864 may include a network interface component or another suitable device to interface with the network 881. In further examples, the communication components 864 may include wired communication components, wireless communication components, cellular communication components, and other communication components to provide communication via other modalities. The devices 880 may be another machine or any of a wide variety of peripheral devices (e.g., a peripheral device coupled via a universal serial bus (USB)). For example, as noted above, the machine 800 may correspond to any one of the client device 112, the compute service manager 108, and the execution platform 110, and may include any other of these systems and devices.

The various memories (e.g., 830, 832, 834, and/or memory of the processor(s) 810 and/or the storage unit 831) may store one or more sets of instructions 815 and data structures (e.g., software), embodying or utilized by any one or more of the methodologies or functions described herein. These instructions 815, when executed by the processor(s) 810, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 881 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 881 or a portion of the network 881 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 815 may be transmitted or received over the network 881 using a transmission medium via a network interface device (e.g., a network interface component included in the communication components 864) and utilizing any one of a number of well-known transfer protocols (e.g., hypertext transfer protocol (HTTP)). Similarly, the instructions 815 may be transmitted or received using a transmission medium via the coupling 882 (e.g., a peer-to-peer coupling) to the devices 880. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 815 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A computer system comprising:
at least one hardware processor; and
at least one memory storing instructions that cause the at least one hardware processor to perform operations comprising:
modifying a large language model (LLM) to skip processing of a subset of layers for input tokens by:
determining a modified architecture for the LLM that skips the subset of layers; and
training the modified LLM via distillation to configure parameter weightings for the modified architecture for the LLM;
receiving a text input query from a first user;
processing the text input query using the modified LLM to receive a response from the LLM; and
causing display of the query response to the first user.

2. The computer system of claim 1, wherein to skip the processing of the subset of layers comprise adjusting a forward pass of the LLM to skip the computational processing of the subset of layers and to use outputs from an earlier layer to populate a Key-Value (KV) cache for the skipped layers.

3. The computer system of claim 1, wherein the modified LLM processes all of the layers corresponding to output tokens for the LLM.

4. The computer system of claim 1, wherein modifying the LLM further comprises skipping processing of another subset of layers for output tokens of the LLM.

5. The computer system of claim 1, wherein the operations further comprise comparing an output of a current hidden layer with an output of a previous hidden layer to determine whether to skip the current hidden layer in the skipping of the subset of layers.

6. The computer system of claim 5, wherein comparing the output of the current hidden layer with the output of the previous hidden layer comprises determining whether a difference between the output of the current hidden layer and the output of the previous hidden layer is within a threshold, and in response to determining that the difference is within the threshold, skipping the current hidden layer.

7. The computer system of claim 5, wherein the current hidden layer is the last hidden layer adjacent to the output layer, wherein the operations further comprise, in response to determining to skip the current hidden layer:
repeatedly and sequentially comparing prior layers to the last hidden layer with previous layers of individual prior layers to determine whether to skip the prior layers until one of the prior layers are not skipped.

8. The computer system of claim 5, wherein comparing the output of the current hidden layer with the output of the previous hidden layer comprises generating a first number representative of the outputs to nodes of the current hidden layer and a second number representative of the outputs to the nodes of the previous hidden layer using cosine similarity.

9. The computer system of claim 1, wherein training the modified LLM comprises performing distillation on the modified LLM by comparing outputs of the modified LLM that is set as a student model with outputs of the original unmodified LLM set as a teacher model to reduce differences between the student model and the teacher model.

10. The computer system of claim 1, wherein modifying the LLM further comprises skipping a subset of nodes of an unskipped layer.

11. The computer system of claim 1, wherein skipping processing of the subset of layers comprises skipping a subset of nodes of a skipped layer.

12. The computer system of claim 1, wherein modifying the LLM is based on a length characteristic of a prompt or query such that multiple modified LLMs are generated for certain prompt or query lengths.

13. The computer system of claim 1, wherein the operations further comprise modifying the LLM based on a geographic location of users, such that multiple modified LLMs are generated for certain geographic locations.

14. The computer system of claim 1, wherein modifying the LLM comprises generating multiple modified versions of the LLM, each modified version skipping a different subset of layers, and training each modified version using a teacher-student distillation process to enhance parameter weightings for the respective modified architecture.

15. The computer system of claim 14, wherein the operations further comprise testing the performance of each modified version of the LLM using one or more predefined metrics, and selecting a modified version of the LLM for deployment during inference based on a balance between computational efficiency and output quality as determined by the predefined metrics.

16. The computer system of claim 1, wherein modifying the LLM further comprises merging Key-Value (KV) caches of hidden layers in groups to reduce memory usage during inference.

17. The computer system of claim 16, wherein merging the KV caches is applied to the same subset of layers that are skipped during input token processing.

18. The computer system of claim 16, wherein merging the KV caches comprises merging smaller groups of layers near the input layer and larger groups of layers near the output layer.

19. A method performed by at least one hardware processor, the method comprising:
modifying a large language model (LLM) to skip processing of a subset of layers for input tokens by:
determining a modified architecture for the LLM that skips the subset of layers; and
training the modified LLM via distillation to configure parameter weightings for the modified architecture for the LLM;
receiving a text input query from a first user;
processing the text input query using the modified LLM to receive a response from the LLM; and
causing display of the query response to the first user.

20. The method of claim 19, wherein to skip the processing of the subset of layers comprise adjusting a forward pass of the LLM to skip the computational processing of the subset of layers and to use outputs from an earlier layer to populate a Key-Value (KV) cache for the skipped layers.

21. The method of claim 19, wherein the modified LLM processes all of the layers corresponding to output tokens for the LLM.

22. The method of claim 19, wherein modifying the LLM further comprises skipping processing of another subset of layers for output tokens of the LLM.

23. The method of claim 19, wherein the method comprises comparing an output of a current hidden layer with an output of a previous hidden layer to determine whether to skip the current hidden layer in the skipping of the subset of layers.

24. The method of claim 19, wherein training the modified LLM comprises performing distillation on the modified LLM by comparing outputs of the modified LLM that is set as a student model with outputs of the original unmodified LLM set as a teacher model to reduce differences between the student model and the teacher model.

25. The method of claim 19, wherein modifying the LLM further comprises skipping a subset of nodes of an unskipped layer.

26. The method of claim 19, wherein skipping processing of the subset of layers comprises skipping a subset of nodes of a skipped layer.

27. The method of claim 19, wherein modifying the LLM is based on a length characteristic of a prompt or query such that multiple modified LLMs are generated for certain prompt or query lengths.

28. The method of claim 19, wherein the operations further comprise modifying the LLM based on a geographic location of users, such that multiple modified LLMs are generated for certain geographic locations.

29. The method of claim 19, wherein modifying the LLM comprises generating multiple modified versions of the LLM, each modified version skipping a different subset of layers, and training each modified version using a teacher-student distillation process to enhance parameter weightings for the respective modified architecture.

30. Computer-storage media comprising instructions that, when executed by one or more processors of a machine, configure the machine to perform operations comprising:
modifying a large language model (LLM) to skip processing of a subset of layers for input tokens by:
determining a modified architecture for the LLM that skips the subset of layers; and
training the modified LLM via distillation to configure parameter weightings for the modified architecture for the LLM;
receiving a text input query from a first user;
processing the text input query using the modified LLM to receive a response from the LLM; and
causing display of the query response to the first user.
